(19) United States
(12) Patent Application Publication
(10) Pub. No.: US 2006/0044123 A1
(43) Pub. Date: Mar. 2, 2006

(54) Monitoring system of car with driving mirrors having monitors disposed thereon

(76) Inventor: Shin-Ho Chen, Taipei County (TW)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 10/983,529

(22) Filed: Nov. 8, 2004

(30) Foreign Application Priority Data
Sep. 2, 2004 (TW) 93213976

(51) Int. Cl. B60Q 1/00; H04N 7/18; G02B 5/08

(52) U.S. Cl. 340/435; 348/148; 359/844

(57) ABSTRACT

A monitoring system for a vehicle is provided. The monitoring system includes at least one mirror having at least one first camera lens disposed thereon, wherein the first camera lens monitors an environment at a front side of the vehicle.

### FIELD OF THE INVENTION

This invention relates to a monitoring system, and more particularly to a monitoring system for a car.

### BACKGROUND OF THE INVENTION

Speaking of driving, a raw recruit, or even an experienced driver, must have had the experience of colliding with some object, such as a car or a fixture, when backing a car, due to an unclear sight. Therefore, a radar monitoring system for car backing has been recently developed to solve the above problem, as shown in FIG. 1. The radar monitoring system has at least one camera lens 12 disposed at the rear side of the car 11. Accordingly, the driver can judge the distance between the car 11 and the object at the rear side by watching the images displayed on the monitor (not shown) inside the car. The images are transmitted from the camera lens 12 when backing the car so as to avoid collision. However, the driver are only allowed to get the view at the rear side of the car through the radar monitoring system. This often results in collision with other objects when backing the car, and thus the driver has to spend much money on repairing the car.

From above description, it is known that how to develop a new monitoring system for a car with the advantage of preventing the car from colliding with other objects has become a major problem to be solved. In order to overcome the drawbacks in the prior art, an improved monitoring system for a car is provided in the present invention. The provided monitoring system not only solves the problem described above, but is simple and easy to be performed.

### SUMMARY OF THE INVENTION

In accordance with one aspect of the present invention, an improved monitoring system for a car is provided. The monitoring system has camera lenses disposed on the driving mirrors of the car. When the car is backed, the camera lenses are aimed at salients at the front side of the car and images thereof are transmitted to the monitor inside the car. With the cooperation of the conventional radar monitoring system for car backing, the driver can easily control the situation around the car during car backing. This efficiently prevents the car from colliding with other objects.

In accordance with another aspect of the present invention, a monitoring system for a vehicle includes at least one mirror having at least one first camera lens disposed thereon, wherein the first camera lens monitors an environment at a front side of the vehicle.

Preferably, the first camera lens is aimed at a salient at the front side of the vehicle.

Preferably, the first camera lens is aimed at the salient at a front right side of the vehicle.

Preferably, the first camera lens is aimed at the salient at a front left side of the vehicle.

Preferably, the vehicle is a car.

Preferably, the mirror further comprises a turn signal disposed thereon.

Preferably, the mirror further comprises at least one sensor disposed thereon for providing a sound to warn a driver when the vehicle is about to collide with an object.

Preferably, the object is one of another vehicle and a fixture.

Preferably, the first camera lens is one of a charge-coupled device camera lens and a complementary metal-oxide semiconductor camera lens.

Preferably, the monitoring system further includes at least one second camera lens disposed at a rear side of the vehicle for monitoring a back view of the vehicle.

Preferably, the monitoring system further includes a monitor disposed inside the vehicle for displaying images transmitted from the first camera lens and the second camera lens when the vehicle is backed.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is a schematic diagram showing the radar monitoring system for car backing according to the prior art;

FIG. 2 is a schematic diagram showing the monitoring system for car backing according to a preferred embodiment of the present invention;

FIG. 3(a) is a front view of the driving mirror according to a preferred embodiment of the present invention;

FIG. 3(b) is a back view of the driving mirror according to a preferred embodiment of the present invention;

FIG. 4 is a block diagram illustrating the circuit of the monitoring system for car backing according to a preferred embodiment of the present invention; and

FIG. 5 shows the monitor in use according to a preferred embodiment of the present invention.

### DETAILED DESCRIPTION OF THE PREFERRED EMBODIMENT

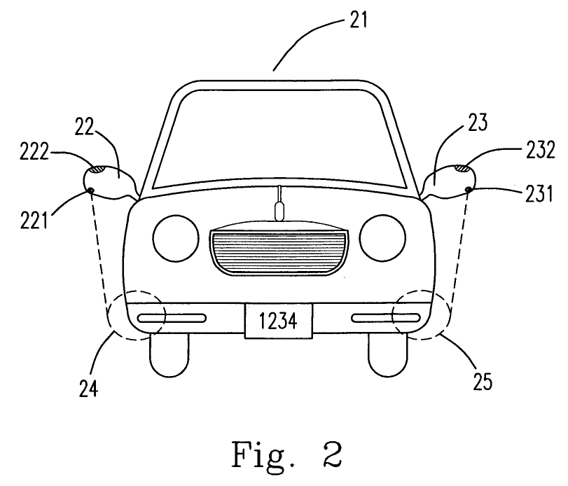

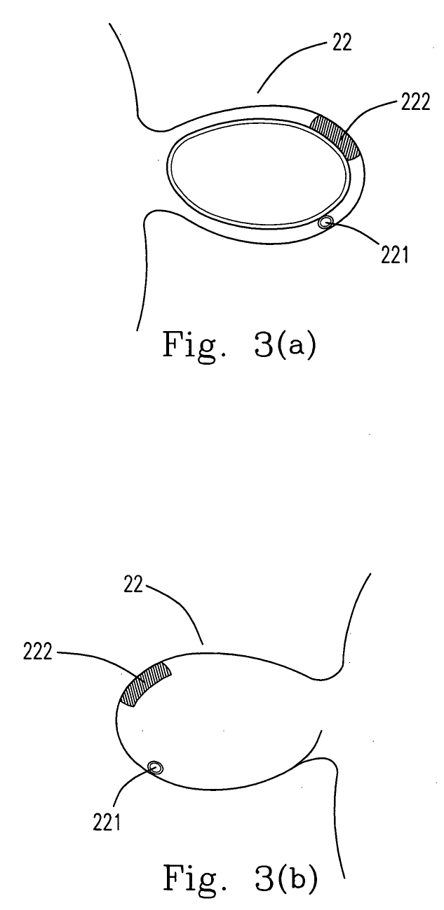

The present invention will now be described more specifically with reference to the following embodiments. Please refer to FIG. 2 and FIGS. 3(a) and 3(b). FIG. 2 shows the monitoring system for car backing according to a preferred embodiment of the present invention. FIGS. 3(a) and 3(b) respectively show the front and back views of the driving mirror according to the preferred embodiment of the present invention. The monitoring system includes two driving mirrors 22 and 23 having the function of monitoring, wherein the driving mirror 22 has a camera lens 221 disposed thereon as shown in FIG. 3(a) and the driving mirror 23 has a camera lens 231 disposed thereon as shown in FIG. 3(b). The environment at the front side of the car 21 are monitored through the camera lenses 22 and 23. The camera lens 22 on the right side is aimed at the salient at the front right side 24 of the car 21, while the camera lens 23 on the left side is aimed at the salient at the front left side 25 of the car 21. Through monitoring the salients at the front right side 24 and the front left side 25 of the car 21, the driver can prevent the car 21 from colliding with other objects when backing the car 21. The camera lenses 22 and 23 are hidden inside the driving mirrors 22 and 23 so that they are not conspicuous and do not occupy any additional space. Preferably, the camera lenses 221 and 231 are charge-coupled device camera lenses or complementary metal-oxide semiconductor ones. Besides, the number of the camera lens on each driving mirror is not limited to one. That is, the number of the camera lens on each driving mirror can be added according to a practical demand.

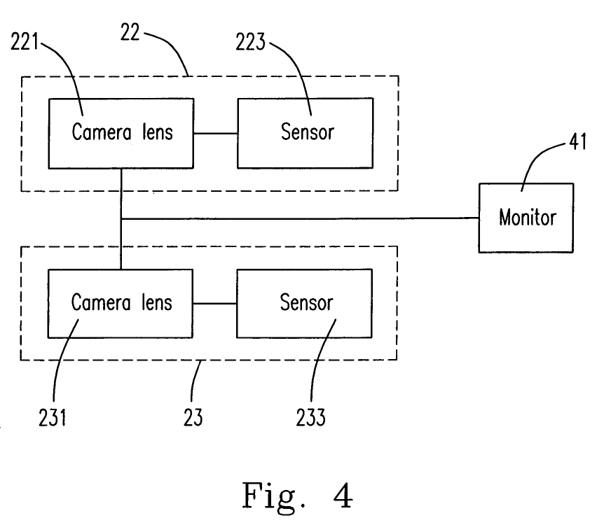

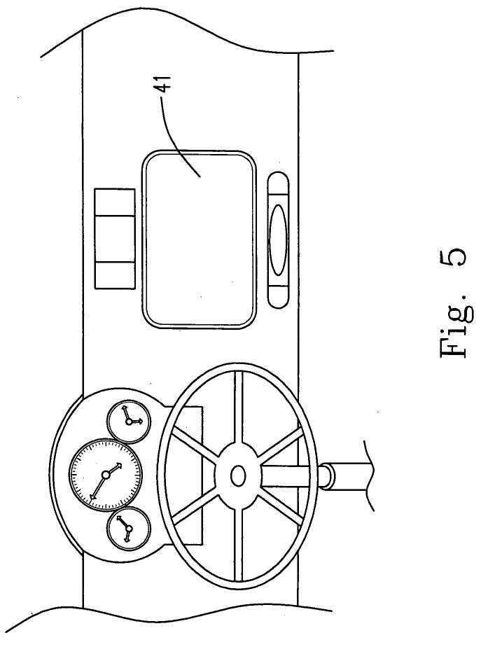

Moreover, the monitoring system of the present invention further includes turn signals 222 and 232 which are respectively disposed on the driving mirrors 22 and 23 to obviously warn the backward vehicles when making a turn. The turn signals 222 and 232 are made of light-emitting diodes or traditional light bulbs. In addition, the monitoring system of the present invention further includes sensors 223 and 233 which are respectively disposed on the driving mirrors 22 and 23 for providing a sound to warn the driver when the car 21 is about to collide with other objects, so as to avoid accidents. Please refer to FIG. 4, which shows the circuit of the monitoring system for car backing according to a preferred embodiment of the present invention. As shown in FIG. 4, the monitoring system of the present invention further includes a monitor 41 disposed inside the car 21 for displaying images transmitted from the respective camera lenses 221 and 231 on the driving mirrors 22 and 23 when the car is backed. Hence, the driver can react properly to the environment according to the images. The use of the monitor 41 is shown in FIG. 5.

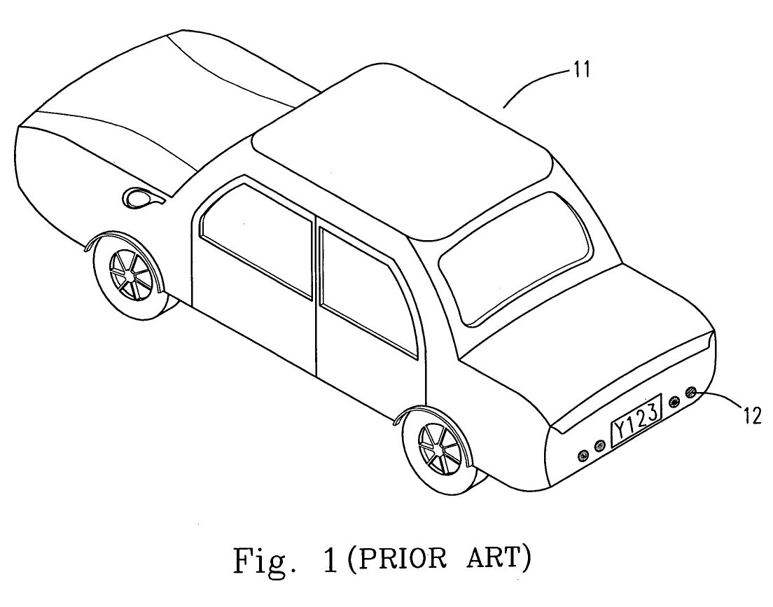

Certainly, the monitoring system of the present invention is combined with the conventional radar monitoring system for car backing to adequately achieve the function of monitoring. Therefore, the monitoring system of the present invention further includes at least one camera disposed at the rear side of the car 21 for monitoring the back view of the car 21. The arrangement of the camera is the same as that in FIG. 1. Because the camera lenses 221 and 231 respectively disposed on the driving mirrors 22 and 23 and the camera lens disposed at the rear side of the car 21 are able to transmit images back to the monitor 41, the images are able to be displayed on the monitor 41 in various ways. For instance, only the image of the front right side of the car 21 is displayed, or the images of the front right and front left sides of the car 21 and those of the rear side of the car 21 are displayed simultaneously. The way of displaying is selected by the driver according to a practical demand.

In conclusion, the monitoring system of the present invention has camera lenses disposed on the driving mirrors. When the car is backed, the camera lenses are aimed at salients at the front side of the car and transmit images thereof to the monitor inside the car. With the cooperation of the conventional radar monitoring system for car backing, the driver can easily control the situation around the car while backing the car. This efficiently prevents the car from colliding with other objects. Accordingly, the present invention can effectively solve the problems and drawbacks in the prior arts, and thus fits the demand of the industry and is industrially valuable.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A monitoring system for a vehicle, comprising:
at least one mirror having at least one first camera lens disposed thereon, wherein said first camera lens monitors an environment at a front side of said vehicle.

2. The monitoring system as claimed in claim 1, wherein said first camera lens is aimed at a salient at said front side of said vehicle.

3. The monitoring system as claimed in claim 2, wherein said first camera lens is aimed at said salient at a front right side of said vehicle.

4. The monitoring system as claimed in claim 2, wherein said first camera lens is aimed at said salient at a front left side of said vehicle.

5. The monitoring system as claimed in claim 1, wherein said vehicle is a car.

6. The monitoring system as claimed in claim 1, wherein said mirror further comprises a turn signal disposed thereon.

7. The monitoring system as claimed in claim 1, wherein said mirror further comprises at least one sensor disposed thereon for providing a sound to warn a driver when said vehicle is about to collide with an object.

8. The monitoring system as claimed in claim 7, wherein said object is one of another vehicle and a fixture.

9. The monitoring system as claimed in claim 1, wherein said first camera lens is one of a charge-coupled device camera lens and a complementary metal-oxide semiconductor camera lens.

10. The monitoring system as claimed in claim 1, further comprising at least one second camera lens disposed at a rear side of said vehicle for monitoring a back view of said vehicle.

11. The monitoring system as claimed in claim 10, further comprising a monitor disposed inside said vehicle for displaying images transmitted from said first camera lens and said second camera lens when said vehicle is backed.
